(19) United States
(12) Patent Application Publication
(10) Pub. No.: US 2023/0001737 A1
(43) Pub. Date: Jan. 5, 2023

(54) MULTILAYER FILM AND USE THEREOF AS A BARRIER EFFECT FOR TEXTILE APPLICATIONS

(71) Applicant: FRAMIS ITALIA S.P.A., Gaggiano, Milano (IT)

(72) Inventor: Rosangela OLIVA, Milano (IT)

(21) Appl. No.: 17/778,753

(22) PCT Filed: Nov. 29, 2019
(86) PCT No.: PCT/IB2019/060030

§ 371 Date: May 20, 2022

(30) Foreign Application Priority Data
Nov. 21, 2019 (IT) 102019000021771

(51) Int. Cl. B44C 1/17; B32B 7/027; B32B 27/08; B32B 27/18; B32B 27/40; B32B 38/00

(52) U.S. Cl. CPC B44C 1/1716; B32B 7/027; B32B 27/08; B32B 27/18; B32B 27/40; B32B 38/145; B32B 2250/03; B32B 2250/24; B32B 2250/40; B32B 2307/738; B32B 2307/732; B32B 2307/73; B32B 2307/75; B32B 2451/00; B32B 2355/00

(57) ABSTRACT

A thermo-adhesive multilayer film based on thermoplastic polyurethane includes a barrier layer having a material with anti-dye migration properties selected from: ethylene vinyl alcohol copolymer, polyvinyl alcohol, polyvinyl acetate, polyamides, cellulose derivatives, polyvinylidene chloride and combinations. The barrier layer is interposed between two layers, each having a mixture of a thermoplastic polyurethane with a compatibilizing agent selected from: co-polymers modified with maleic anhydride, co-polymers modified with epoxy groups, co-polymers containing hydroxyl groups and combinations thereof. A decorative multilayer film includes the thermo-adhesive multilayer film and a further decorative layer, which provides an aesthetic effect. A process of co-extruding the layers obtains the thermo-adhesive multilayer film and the subsequent bonding thereof with the decorative layer obtains the decorative multilayer film. The decorative multilayer film decorates substrates in the field of textiles, clothing, footwear and accessories. A finished decorated article includes a substrate on which the decorative multilayer film is applied.

### FIELD OF THE INVENTION

The present invention relates to a thermo-adhesive multilayer film based on thermoplastic polyurethane (TPU) for applications in the field of textiles, clothing, footwear and accessories, comprising at least one layer that acts as a barrier layer in order to prevent dye migration from a substrate to which the film is applied towards a decorative layer.

### STATE OF THE ART

In the textile industry, in particular in the manufacture of fabrics, items of clothing, footwear, accessories and the like, it is common to use thermoplastic polyurethane-based multilayer films that serve to make a decorative layer adhere to fabrics, items of clothing, footwear, accessories and the like. The decorative layer normally has a certain colour and/or a decorative motif, such as, for example an image, wording, a logo, a mark, a pattern, a design motif etc.

Polyurethane-based multilayer films are generally obtained by spreading and/or extruding different layers and comprise at least one adhesive layer made of thermoplastic polyurethane or mixtures of polyurethane with other thermoplastic materials compatible with polyurethane, in varying percentages, also referred to as hot melt layer, and at least one upper decorative layer or top layer, likewise comprising a polyurethane or mixtures of polyurethane with other thermoplastic materials compatible with polyurethane, in varying percentages, and optionally one or more dyes and/or pigments. The top layer can also be composed of fabric. The top decorative layer can further undergo printing processes in order to obtain particular decorative motifs or it can undergo laser engraving or plotter cutting. For example, the top decorative layer can have a white colour obtained by adding the pigment TiO₂ to the thermoplastic polyurethane or other types of pigments and/or dyes and can have decorative motifs, such as, for example images, wording, drawings, logos, pattern, design motifs etc. The lower adhesive hot melt layer, by contrast, is generally low melting point thermoplastic polyurethane which is activated with heat and enables the adhesion of the multilayer to the desired substrate (fabric, item of clothing etc.).

One problem that is commonly encountered in the sector during the step of applying the heat necessary to make the multilayer adhere to the substrate, for example by means of a hot press, an iron or a thermal welding machine, is that the dye of the substrate can migrate, over a shorter or longer term, through the various layers of the multilayer and become mixed with the dye of the decorative layer, thus spoiling and compromising the desired aesthetic effect.

In the prior art, this problem is resolved by making a multilayer film comprising an intermediate layer interposed between the adhesive layer and the decorative layer. The function of the intermediate layer is that of a “barrier layer”, i.e. a layer consisting of a material that prevents the dye from being able to migrate from the substrate on which the multilayer is applied, rise to the top layer and thus mar the appearance of the finished product.

Materials that can be used for the barrier layer against dye migration are copolymers such as, for example, ethylene vinyl alcohol copolymer (EVOH), polyamides such as, for example, MXD6, polyvinylidene chloride (PVDC) or the like, materials that are commonly used successfully above all in other fields, such as, for example, in the food packaging industry, for their typical properties as a barrier against oxygen and odours.

In the textile industry, however, one of the largest problems connected to the use of such materials lies in the poor adhesion between the barrier layer (based on such materials) and the other layers of the film, with a consequent delamination of the finished multilayer. In fact, as the multilayer is made with materials of a different chemical nature and with different properties of interaction, it poses problems of stability linked to the poor adhesion and compatibility among the various layers.

In the light of the foregoing, it is evident that there is a need in the sector to obtain a thermo-adhesive multilayer film based on thermoplastic polyurethane that comprises a barrier layer against dye migration and at the same time does not give rise to problems of delamination of the layers once co-extruded and once applied to the desired substrate.

In the prior art, some attempts were made to solve this technical problem, for example by inserting additional intermediate layers within the multilayer structure of the film, such as is disclosed, for example, in the patent publication US2012121869. This document describes the use of a barrier layer made of ethylene vinyl alcohol copolymer (EVOH) to prevent dye migration in textile applications. In particular, it suggests using said barrier layer as a layer interposed between an upper decorative layer made of “soft” polyurethane and a lower layer, which can consist of a thermo-adhesive polymer with a function similar to that of a hot melt layer. In one of the embodiments described in US2012121869, the technical problem of the adhesion between the EVOH barrier layer and the other layers is confronted by using two polyurethane-based intermediate layers that have the function of favouring adhesion between the various film layers, as they are in fact interposed respectively between the decorative layer and the barrier layer and between the barrier layer and the lower layer.

In this case, however, the final multilayer film obtained, though it comprises a dye migration preventing barrier layer, has the disadvantage that, in order to assure a more effective adhesion of the various layers within the multilayer film, at least two extra adhesive layers must be added, thus making the extrusion operations for obtaining the final thermo-adhesive film more difficult without, moreover, completely solving the technical problem of delamination of the layers, thermoplastic polyurethane and EVOH materials being by nature scarcely compatible.

There thus remains a need the sector to have a multilayer film with an anti-dye migration barrier effect that does not pose problems of delamination once co-extruded and bonded with the desired decorative layer.

In this context, the object of the present invention is to provide a thermo-adhesive multilayer film that not only has improved anti-dye migration performance compared to the currently available thermo-adhesive multilayer films, but at the same time also has the desired mechanical and adhesion properties, thus overcoming the problems of delamination of the film layers known in the sector.

In particular, the technical problem of the adhesion between layers is overcome by the present invention, which provides a thermo-adhesive multilayer film based on thermoplastic polyurethane that comprises at least one barrier layer comprising at least one material with anti-dye migration properties, whose compatibility with the adjacent multilayer film layers comprising thermoplastic polyurethane, is assured by the presence of a mixture of at least one compatibilizing polymer and a thermoplastic polyurethane.

The use of modified co-polymers (such as, for example, ethylene-vinyl acetate-maleic anhydride terpolymers, known by the trade name OREVAC®, polyolefins grafted with maleic anhydride, likewise known by the trade name OREVAC® or terpolymers based on polyolefins containing functional groups such as maleic anhydride or epoxides—for example glycidyl methacrylate—known by the trade name Lotader® or the like) as compatibilizers to increase the compatibility of mixtures of thermoplastic polyurethanes and polyamides (Pan, Xianlu et al., Journal of Adhesion Science and Technology, 2017, 31(9), pp. 943-957) or of thermoplastic polyurethanes and ethylene vinyl acetate (Ma, Jianzhong et al., Polymer Bulletin 2014, 71(9), pp. 2219-2234) is known in the literature, but the use thereof in mixtures with thermoplastic polyurethanes is not known, nor is it known that such mixtures are capable of increasing the compatibility and adhesion of layers comprising polyurethane or mixtures of polyurethane with other thermoplastic materials in different percentages to a barrier layer comprising at least one material with anti-dye migration properties, as has been demonstrated in the case of the present invention.

The thermo-adhesive multilayer film of the present invention thus solves the problems of the prior art listed above, since it can be easily co-extruded, bonded with a decorative layer and subsequently applied to a variety of different substrates, for example textile substrates, using known industrial and non-industrial systems, without incurring the unpleasant and undesirable effects of dye migration and/or delamination of the layers.

### SUMMARY OF THE INVENTION

The present invention relates to a thermo-adhesive multilayer film based on thermoplastic polyurethane comprising at least one barrier layer B, said barrier layer B comprising at least one material with anti-dye migration properties selected in the group consisting of: ethylene vinyl alcohol copolymer (EVOH), polyvinyl alcohol (PVOH), polyvinyl acetate (PVAc), polyamides, preferably MXD6, cellulose derivatives, preferably cellulose acetate butyrate, polyvinylidene chloride (PVDC) and combinations thereof, said barrier layer B being interposed between at least two layers A and C, each comprising a mixture of at least one thermoplastic polyurethane (TPU) with at least one compatibilizing agent, said at least one compatibilizing agent being selected in the group consisting of co-polymers modified with maleic anhydride, co-polymers modified with epoxy groups, co-polymers containing hydroxyl groups and combinations thereof.

In one embodiment of the invention layers A and C comprise a mixture consisting of from 60 to 99% by weight of the at least one thermoplastic polyurethane and from 1 to 40% by weight of the at least one compatibilizing agent, preferably from 65 to 95% by weight of the at least one thermoplastic polyurethane and from 5 to 35% by weight of the at least one compatibilizing agent, more preferably from 70 to 90% by weight of the at least one thermoplastic polyurethane and from 10 to 30% by weight of the at least one compatibilizing agent, even more preferably from 65 to 80% by weight of the at least one thermoplastic polyurethane and from 20 to 35% by weight of the at least one compatibilizing agent, even more preferably from 65 to 75% by weight of the at least one thermoplastic polyurethane and from 25 to 35% by weight of the at least one compatibilizing agent. The present invention also relates to a decorative multilayer film comprising the thermo-adhesive multilayer film of the invention and a further decorative layer D. Said layer D preferably comprises at least one material selected from among a thermoplastic polyurethane material, a fabric, a nonwoven fabric and combinations thereof; said layer D optionally comprises at least one pigment and/or at least one dye that provides an aesthetic effect. Alternatively, the aesthetic effect can be obtained by printing or laser engraving on the surface of the layer D. The invention also relates to a process of co-extruding the layers in order to obtain the thermo-adhesive multilayer film and the subsequent bonding thereof with a decorative layer in order to obtain the decorative multilayer film, as well as the use of the latter to decorate substrates in the field of textiles, clothing, footwear and accessories. Finally, the invention also relates to a finished decorated article comprising a substrate on which the decorative multilayer film of the invention is applied. Said article can be, for example, a fabric, an item of clothing, footwear, a furnishing element or a fashion accessory.

### BRIEF DESCRIPTION OF THE FIGURES

FIG. 1a schematically shows the thermo-adhesive multilayer film 1 of the invention.

FIG. 1b schematically shows the thermo-adhesive multilayer film 1 of the invention in the embodiment wherein it further comprises a support layer E.

FIG. 2a schematically shows the decorative multilayer film 2 of the invention.

FIGS. 2b and 2c schematically show the decorative multilayer film 2 of the invention in the embodiments respectively further comprising a support layer E and two additional layers: a support layer E and a protective layer F. FIG. 3a schematically shows a decorated article 3 wherein the decorative multilayer film 2 of the invention is applied on a substrate S.

FIG. 3b schematically shows a decorated article 3b wherein the decorative multilayer film 2 of the invention further comprising a protective layer F is applied on a substrate S.

FIG. 4 shows the adhesion test carried out for the decorative multilayer film of test 22 applied on the 73% polyamide and 27% elastane substrate as per example 2.2.

FIG. 5 shows the adhesion tests carried out for the decorative multilayer film of test 22 applied on different substrates as per example 2.2: FIG. 5a 78% polyamide and 22% elastane fabric; FIG. 5b 100% polyester fabric; FIG. 5c 79% polyamide and 21% elastane fabric.

### DETAILED DESCRIPTION OF THE INVENTION

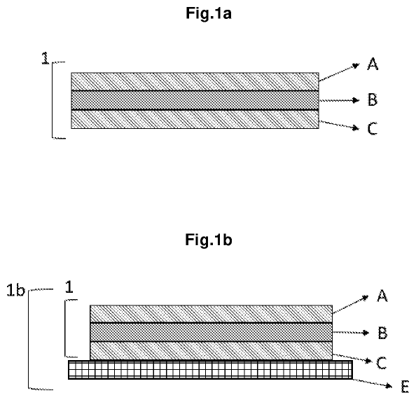

With reference to FIG. 1a, the present invention relates to a thermo-adhesive multilayer film 1 based on thermoplastic polyurethane comprising at least one barrier layer B, said barrier layer B comprising at least one material with anti-dye migration properties selected in the group consisting of: ethylene vinyl alcohol copolymer (EVOH), polyvinyl alcohol (PVOH), polyvinyl acetate (PVAc), polyamides, preferably MXD6, cellulose derivatives, preferably cellulose acetate butyrate, polyvinylidene chloride (PVDC) and combinations thereof, interposed between at least two layers A and C comprising a mixture of at least one thermoplastic polyurethane (TPU) with at least one compatibilizing agent.

Compatibilizing agent means a substance capable of making polymers compatible—polymers that would not be so due to their chemical nature.

The at least one compatibilizing agent of the present invention is a co-polymer selected in the group consisting of co-polymers modified with maleic anhydride, co-polymers modified with epoxy groups, co-polymers containing hydroxyl groups and combinations thereof. Said at least one compatibilizing agent is preferably selected in the group consisting of: ethylene-vinyl acetate-maleic anhydride terpolymers, known by the trade name Orevac®, polyolefins grafted with maleic anhydride, likewise known by the trade name Orevac®, terpolymers based on polyolefins containing functional groups such as maleic anhydride or epoxides—for example glycidyl methacrylate—known by the trade name Lotader®.

In one embodiment, said terpolymers based on polyolefins are ethylene-acrylic ester-maleic anhydride terpolymers, likewise known by the trade name Lotader®. In a particularly preferred embodiment of the invention, said at least one compatibilizing agent is selected from among a polyethylene-vinyl acetate-maleic anhydride terpolymer—known by the trade name Orevac®—or other terpolymers similar thereto or easily derivable therefrom.

Without wishing to be bound to a specific theory, the Applicant has found that it is precisely the use of a mixture of at least one thermoplastic polyurethane (TPU) with said at least one compatibilizing agent that makes it possible to avoid or considerably limit the problem of delamination of the layers making up the thermo-adhesive multilayer film and/or the decorative multilayer film of the invention as described below. In fact, the use of a layer A (or C) consisting solely of the at least one compatibilizing agent or, similarly, consisting solely of the at least one thermoplastic polyurethane, would not allow an effective adhesion to be obtained between the barrier layer and the other layers of the multilayer film of the present invention. Therefore, for the purposes of the present invention, said mixture of at least one thermoplastic polyurethane (TPU) with at least one compatibilizing agent is to be understood and considered as the actual agent that performs a compatibilizing action between the layers. The at least one thermoplastic polyurethane is selected in the group consisting of a polyester-based thermoplastic polyurethane, polycarbonate-based thermoplastic polyurethane, polyether-based thermoplastic polyurethane, aliphatic-based thermoplastic polyurethane, aromatic-based thermoplastic polyurethane and combinations thereof. The at least one thermoplastic polyurethane is preferably an aromatic-based and polyester-based thermoplastic polyurethane. In one embodiment of the invention, layer B comprises the at least one material with anti-dye migration properties in an amount comprised from 90 to 100%, preferably from 95 to 100% by weight, preferably from 99 to 100% by weight. Said at least one material with anti-dye migration properties is preferably ethylene vinyl alcohol copolymer (EVOH). In a preferred embodiment of the invention, layer B comprises from 90 to 100%, preferably from 95 to 100% by weight, preferably from 99 to 100% by weight of EVOH. In one embodiment of the invention, layer A and layer C each comprise a mixture consisting of 60 to 99% by weight of the at least one thermoplastic polyurethane and from 1 to 40% by weight of the at least one compatibilizing agent, preferably from 65 to 95% by weight of the at least one thermoplastic polyurethane and from 5 to 35% by weight of the at least one compatibilizing agent, more preferably from 70 to 90% by weight of the at least one thermoplastic polyurethane and from 10 to 30% by weight of the at least one compatibilizing agent, even more preferably from 65 to 80% by weight of the at least one thermoplastic polyurethane and from 20 to 35% by weight of the at least one compatibilizing agent, even more preferably from 65 to 75% by weight of the at least one thermoplastic polyurethane and from 25 to 35% by weight of the at least one compatibilizing agent.

In a preferred embodiment of the invention, layer A and layer C comprise a mixture comprising from 60 to 99% by weight of the at least one thermoplastic polyurethane and from 1 to 40% by weight of a co-polymer modified with maleic anhydride, preferably from 65 to 95% by weight of the at least one thermoplastic polyurethane and from 5 to 35% by weight of a co-polymer modified with maleic anhydride, more preferably from 70 to 90% by weight of the at least one thermoplastic polyurethane and from 10 to 30% by weight of a co-polymer modified with maleic anhydride, even more preferably from 65 to 80% by weight of the at least one thermoplastic polyurethane and from 20 to 35% by weight of a co-polymer modified with maleic anhydride, even more preferably from 65 to 75% by weight of the at least one thermoplastic polyurethane and from 25 to 35% by weight of a co-polymer modified with maleic anhydride.

In a particularly preferred embodiment of the invention, layer A and layer C comprise a mixture comprising from 60 to 99% by weight of the at least one thermoplastic polyurethane and from 1 to 40% by weight of an ethylene-vinyl acetate-maleic anhydride terpolymer, preferably from 65 to 95% by weight of the at least one thermoplastic polyurethane and from 5 to 35% by weight of an ethylene-vinyl acetate-maleic anhydride terpolymer, more preferably from 70 to 90% by weight of the at least one thermoplastic polyurethane and from 10 to 30% by weight of an ethylene-vinyl acetate-maleic anhydride terpolymer, even more preferably from 65 to 80% by weight of the at least one thermoplastic polyurethane and from 20 to 35% by weight of an ethylene-vinyl acetate-maleic anhydride terpolymer, even more preferably from 65 to 75% by weight of the at least one thermoplastic polyurethane and from 25 to 35% by weight of an ethylene-vinyl acetate-maleic anhydride terpolymer. In one embodiment of the invention, layer A and layer C comprise a mixture comprising from 65% to 75% by weight of a thermoplastic polyurethane and from 25% to 35% by weight of an ethylene-vinyl acetate-maleic anhydride terpolymer and layer B consists of 99% to 100% by weight of the at least one material with anti-dye migration properties, said material preferably being EVOH.

The Applicant has found that the presence of at least one compatibilizing agent in a mixture with the at least one thermoplastic polyurethane of layers A and C makes it possible to avoid the problem of delamination of the various layers of the multilayer film both before and after the multilayer adhesive film has undergone dry cleaning or washing with water. In a preferred embodiment of the invention, said mixture of the at least one compatibilizing agent with the at least one thermoplastic polyurethane of layers A and C is a compound, obtained by means of a compounding process in an extruder, of the at least one compatibilizing agent and the at least one thermoplastic polyurethane in the same percentage amounts described previously. In other words, said layers A and C can comprise the at least one compatibilizing agent in a mixture with the at least one thermoplastic polyurethane, said mixture being:
(i) a mixture obtained by direct mixing, in an extruder, of the at least one compatibilizing agent with the at least one thermoplastic polyurethane;
(ii) or, alternatively, according to a preferred embodiment, said mixture being obtained by extrusion of a compound obtained through a process of compounding, in a previous extruder, of the at least one compatibilizing agent with the at least one thermoplastic polyurethane.

This second embodiment is particularly preferred, since the formation of said compound makes it possible to obtain a more homogeneous mixture of the at least one compatibilizing agent with the at least one thermoplastic polyurethane once layers A and C have been formed. For both embodiments, the Applicant has in any case demonstrated the advantages connected to said mixture, which enables the problems of delamination of the various layers of the multilayer film of the invention to be avoided or considerably reduced. This result is surprising if one considers that, as demonstrated by the Applicant in the comparative experiments included in the examples section, in the configuration wherein the at least one compatibilizing agent is used in a layer that is separate from the polyurethane layer, and interposed between the barrier layer B and the other polyurethane layers, delamination occurs. In other words, without wishing to be bound to a specific theory, the Applicant has found that using a layer consisting solely of the at least one compatibilizing agent does not provide the same performance in terms of adhesion between the layers of the multilayer film that one obtains, by contrast, when the same at least one compatibilizing agent is used in a mixture (as described above) with at least one thermoplastic polyurethane. The Applicant has also surprisingly found, as shown by the experiments conducted and included herein, that the best results in terms of resistance to delamination are obtained when the rheological properties, measured using the melt flow rate (MFR) measured at 190° C. and 2.16 kg (according to standard ISO 1133), of the thermoplastic polyurethane, the material of the barrier layer and the compatibilizing agent are similar. Similar rheological properties means that the three materials show a value of the MFR measured at 190° C. and 2.16 kg (according to standard ISO 1133) such that the difference between the MFR of the thermoplastic polyurethane and that of the material of the barrier layer is comprised between 10 g/10′ and 35 g/10′, preferably between 12 g/10′ and 32 g/10′, more preferably between 14 g/10′ and 20 g/10′, and the difference between the MFR of the compatibilizing agent and that of the material of the barrier layer is comprised between 2 g/10′ and 5 g/10′.

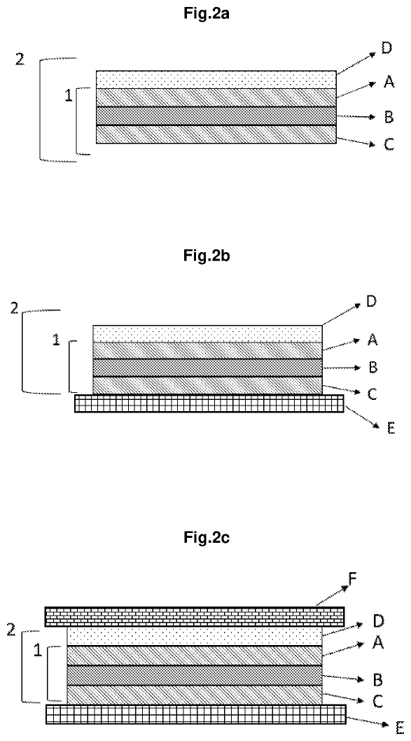

The Applicant has also verified that the concentrations of the thermoplastic polymer and of the compatibilizing agent in layers A and C can be varied within the specified intervals (1-40% by weight, preferably 5-35% by weight, more preferably 25-35% by weight of compatibilizing agent) based on the properties in terms of the melt flow index of the same compared to the melt flow index of the material of the barrier layer B. For example, if it is desired to use a thermoplastic polyurethane with a melt flow index similar to that of the barrier layer material, it is possible to increase the concentration thereof and decrease that of the compatibilizing agent in the mixture of layer A or C; on the other hand, if the melt flow index of the thermoplastic polyurethane deviates from that of the barrier layer material, it will be necessary to decrease the concentration of the polyurethane and increase that of the compatibilizing agent. Furthermore, the Applicant has demonstrated with the experiments included herein that better anti-delamination properties and better aesthetic effects can be obtained when the mixture between the thermoplastic polymer and compatibilizing agent is obtained by extrusion, that is, when a compound is prepared. In particular, if the extruder used to form the compound is a twin-screw extruder, the process of mixing the two materials will be more intimate, with the consequent formation of a more uniform mixed compound that has better aesthetic effects. The thermo-adhesive multilayer film of the invention is obtained by means of an extrusion process that enables bonding of the various film layers. The extrusion process is preferably conducted with an extruder, preferably a triple-screw extruder for co-extruding layers A, B and C so as to obtain a multilayer film as shown in FIG. 1a. The extrusion process is preferably conducted at a temperature comprised between 170 and 220° C. According to a preferred embodiment, layer A and/or layer C can be extruded using a support (support layer E) so as to obtain the thermo-adhesive multilayer film as shown in FIG. 1b. Said support layer E is selected in the group consisting of: paper silicone-coated on one side, paper silicone-coated on two sides, PET and combinations thereof. Alternatively, said layer E can be a layer comprising polyethylene which is co-extruded simultaneously with the co-extrusion of the layers A, B and C. In one embodiment, the present invention relates therefore to a thermo-adhesive multilayer film 1b based on thermoplastic polyurethane comprising at least one barrier layer B, said barrier layer B comprising at least one material with anti-dye migration properties selected in the group consisting of: ethylene vinyl alcohol copolymer (EVOH), polyvinyl alcohol (PVOH), polyvinyl acetate (PVAc), polyamides, preferably MXD6, cellulose derivatives, preferably cellulose acetate butyrate, polyvinylidene chloride (PVDC) and combinations thereof, interposed between at least two layers A and C comprising a mixture of at least one thermoplastic polyurethane (TPU) with at least one compatibilizing agent, said thermo-adhesive multilayer film further comprising at least one support layer E applied to layer A and/or C. In one embodiment of the invention, layer A has a thickness comprised between 10 and 50 μm, preferably between 30 and 40 μm, more preferably between 35 and 45 μm, whilst layer C has a thickness comprised between 10 and 90 μm, preferably between 30 and 50 μm. The thickness of the barrier layer B, on the other hand, is comprised between 1 and 70 μm, preferably between 10 and 30 μm, even more preferably between 15 and 25 μm. Calibration of the thickness of the barrier layer makes it possible to obtain a thermo-adhesive multilayer film with excellent anti-dye migration properties, and which thus also works well as a protective barrier film. In fact, if layer B comprising at least one material with anti-dye migration properties is too thin, at the time of extrusion with the other layers there could be areas in which said at least one material with anti-dye migration properties is not present, with the consequence of impairing the desired barrier properties. However, if the thickness of layer B is too great, the thermo-adhesive multilayer film would have excessive stiffness as well as little elasticity; these are unpleasant, undesirable characteristics, particularly in the case of applications in the field of textiles, clothing or footwear. In one embodiment, the invention also relates to a decorative multilayer film 2 comprising the thermo-adhesive multilayer film as described above and a decorative layer D (see FIGS. 2a, 2b and 2c).

In the decorative multilayer film, the decorative layer D can be applied to layer A or, alternatively, to layer C. As layers A and C substantially coincide from the standpoint of their composition, they are interchangeable and can act as hot-melt, i.e. heat activatable, adhesives for anchoring the decorative layer D.

In a preferred embodiment of the invention, the multilayer film to which the decorative layer D is applied also comprises a support layer E, as previously described, said layer E being applied to layer A or, alternatively, to layer C. Advantageously, said support layer E makes it possible to prevent the layer of the multilayer film not in contact with D (i.e. layer C or A, respectively) from becoming attached to the apparatus used for bonding, during the bonding of the decorative layer D with the multilayer film (i.e. with layer A or C).

FIG. 2a shows an example of the decorative multilayer film wherein the decorative layer D is applied to the polyurethane layer A.

FIG. 2b shows a preferred embodiment of the invention, wherein the decorative layer D is applied to the polyurethane layer A and the support layer E is applied to the polyurethane layer C.

In one embodiment of the invention, the decorative multilayer film has a further layer F applied to the layer D, said layer F being a protective layer selected in the group consisting of: PET, adhesive PET, paper and combinations thereof. Said layer F has the function of protecting the decorative layer D, facilitating the plotter cutting and laser cutting processes and/or preserving the aesthetics thereof over time.

The decorative multilayer film 2 has the same characteristics of resistance to delamination and anti-dye migration properties as the thermo-adhesive multilayer film 1 described above.

The process for obtaining the decorative multilayer film comprises a step of bonding the thermo-adhesive multilayer film of the invention, preferably the thermo-adhesive multilayer film 1b, with a decorative layer D at a temperature comprised between 50 and 250° C., preferably between 100 and 150° C., even more preferably between 110 and 130° C., at a calendering speed comprised between 1 m/min and 10 m/min, preferably comprised between 2 m/min and 6 m/min, and an applied pressure of between 0.2 and 40 bar.

The decorative layer D comprises at least one material selected from among a thermoplastic polyurethane material (i.e. thermoplastic polyurethane), a fabric, a nonwoven fabric and combinations thereof.

Said thermoplastic polyurethane material is preferably a material that is stable up to high temperatures, preferably selected in the group consisting of polyester-based thermoplastic polyurethane, polycarbonate-based thermoplastic polyurethane, polyether-based thermoplastic polyurethane, aliphatic-based thermoplastic polyurethane, aromatic-based thermoplastic polyurethane and combinations thereof, preferably aromatic-based and polyester-based thermoplastic polyurethane.

In a preferred embodiment of the invention said decorative layer D further comprises at least one pigment and/or at least one dye for the purpose of imparting a particular aesthetic effect to the final layer.

Said at least one pigment can be selected from among an inorganic solid, an organic particulate or a pigmented paste and combinations thereof.

Said at least one pigment preferably maintains a crystalline or particulate structure during the dyeing process.

Said at least one pigment is preferably selected from among a coloured, black, white or fluorescent pigment or combinations thereof.

Said at least one dye can be selected in the group consisting of a coloured organic substance, a fluorescent organic substance and combinations thereof.

Said at least one dye preferably loses its crystalline or particulate structure during the dyeing process.

In one embodiment, the decorative layer D has a decoration selected in the group consisting of an image, wording, a drawing, a logo, a mark, a geometric pattern or a design motif. Layer D of the invention can in fact undergo a printing process in order to obtain said decoration or other decorative motifs.

In one embodiment, the multilayer A-B-C, once bonded to the layer D, can be entirely engraved with laser or cut with a plotter to create the desired decorative form.

In one embodiment, the decorative layer D is a double layer (i.e. a bilayer) comprising an upper layer called the “skin” or top layer (which possesses all of the characteristics of the decorative layer D as described above) and a lower polyurethane-based adhesive layer (hot melt layer) to be bonded with the multilayer film of the invention. Said embodiment is particularly advantageous for the purposes of the present invention, since it enables a more effective bonding of the decorative layer to layer A or C of the multilayer film of the invention to be obtained.

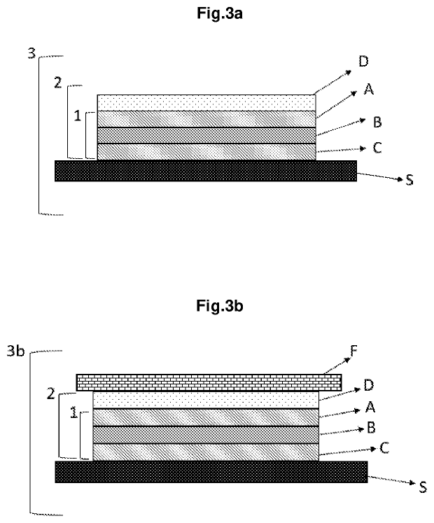

The decorative multilayer film of the invention is used to decorate a substrate S (or a part thereof) on which it is applied by heat activation of layer A or C, so as to obtain a decorated article 3, exemplified in FIG. 3.

In FIG. 3, layer C is the lower layer of the adhesive multilayer film which is applied on the substrate S. Layer C has the function of the classic hot melt layers made of thermoplastic polyurethane, well known in the sector, which enable the adhesion of the thermo-adhesive multilayer film to the desired substrate S following activation with heat and without any need to add other layers.

FIG. 3b instead shows the embodiment wherein the decorative multilayer film further comprising a protective layer F bonded to the decorative layer D is applied on the desired substrate S, so as to obtain a decorated article 3b. In a preferred embodiment of the present invention, said protective layer F is removed after being applied by heat on the substrate S.

The substrate S is selected in the group consisting of materials for applications in the field of textiles, clothing and footwear or design, such as, for example, fabrics or nonwoven fabrics made of natural or synthetic fibres.

The activation of layer A or C is achieved by heating to a temperature comprised between 90 and 160° C., preferably between 100 and 150° C., even more preferably between 120 and 140° C., for a time comprised between 10 and 30 seconds, preferably between 15 and 25 seconds. The heating is preferably carried out with a heating device, for example an oven or an IR or UV lamp, a hot roller, a hot press, an iron or thermal welding machines.

In the embodiment wherein a support layer E is applied to the layer A or C, said support layer E is removed before said activation step.

After the heat activation of layer A or C, the thermo-adhesive multilayer film can be applied on the substrate and will adhere thereto.

Therefore, the subject matter of the invention relates to the use of the decorated multilayer film to decorate substrates belonging to the sector of textiles, shoes, clothing, accessories and furnishing elements, such as, for example, items of clothing, shoes, belts, handbags and fashion accessories.

The invention further relates to a decorated article obtained following application of the decorative multilayer film on a substrate, which can be a fabric, a nonwoven fabric, an item of clothing, footwear or an accessory.

Said decorated article, by virtue of the barrier properties of the thermo-adhesive multilayer film and, consequently, of the decorative multilayer film of the invention, does not pose any problems tied to dye migration between the substrate S on which the multilayer film of the invention is applied and the decorative layer D.

### EXAMPLES OF EMBODIMENTS AND COMPARATIVE EXAMPLES

### Materials and Methods

The materials used in the experiments described below were purchased from the suppliers listed in table 1 and stored and used according to the instructions provided in the technical datasheet of each product.

TABLE 1

| Materials | Description | MFR [g/10′] | |
|---|---|---|---|
| EVOH-1 | EVOH barrier material | 8 | (190° C. - 2.16 kg) |
| EVOH-2 | EVOH barrier material | 1.5 | (190° C. - 2.16 kg) |
| EVOH-3 | EVOH barrier material | 6 | (190° C. - 2.16 kg) |
| TPU-1 | Thermoplastic polyurethane | 20 | (190° C. - 2.16 kg) |
| TPU-2 | Thermoplastic polyurethane | 35 | (190° C. - 2.16 kg) |
| TER | Compatibilizing terpolymer | 8 | (190° C. - 2.16 kg) |

Legend: MFR stands for melt flow rate

Every extrusion test performed required an entire day of production. The extruder was cleaned at the end of every single extrusion.

In the example family 1 extrusion tests were performed with thermo-adhesive multilayer films with a barrier effect according to the prior art.

### Example 1.1

Three extrusion tests were performed with a thermo-adhesive multilayer film in which layers A and C did not include the presence of a compatibilizing agent, as in the multilayer films of the prior art.

TABLE 2

| | Materials | Test 1 | Test 2 | Test 3 |
|---|---|---|---|---|
| Layer A | TPU-1 | 100% | 100% | 100% |
| | TER | 0% | 0% | 0% |
| Layer B | EVOH | 100% | 100% | 100% |
| | | EVOH-2 | EVOH-1 | EVOH-3 |
| Layer C | TPU-1 | 100% | 100% | 100% |
| | TER | 0% | 0% | 0% |

For all three tests, layers with the following thicknesses were used:
layer A: 25 μm
layer B: 10 μm
layer C: 65 μm

In the case of test 1 it was not possible to co-extrude the TPU/EVOH/TPU trilayer due to the marked differences in the behaviour of the two materials under the working conditions applied to carry out the extrusion.

In tests 2 and 3, by contrast, it was possible to co-extrude the trilayer. However, in both cases, following the extrusion, the trilayer showed problems of delamination at the TPU/EVOH interface (i.e. the interface between layer A and B and between layer B and C), a problem it was not possible to solve in any way.

These tests show that the addition of an EVOH-based barrier layer within a thermoplastic polyurethane-based multilayer film leads to a destabilisation of the multilayer itself caused by the poor compatibility between TPU and EVOH and the production of a co-extruded product prone to problems of delamination of the layers.

### Example 1.2

Two extrusion tests were carried out with a decorative multilayer film with barrier properties, wherein layers A and C consisted wholly of a compatibilizing agent.

TABLE 3

| | Materials | Test 4 | Test 5 |
|---|---|---|---|
| Layer A | TPU-1 | 0% | 0% |
| | TER | 100% | 100% |
| Layer B | EVOH-3 | 100% | 100% |
| Layer C | TPU-1 | 0% | 0% |
| | EVOH-3 | 100% | 100% |

For test 4, layers with the following thicknesses were used:
layer A: 10 μm
layer B: 10 μm
layer C: 80 μm
   whereas test 5 was carried out using layers having the following thicknesses:
layer A: 10 μm
layer B: 10 μm
layer C: 10 μm

In both cases it was possible to successfully co-extrude the compatibilizing agent/EVOH/compatibilizing agent trilayer, where layer C was subsequently bonded with a thermoplastic polyurethane layer C′ having the function of a hot melt layer, and layer A was subsequently bonded with a decorative layer D, likewise made of thermoplastic polyurethane.

The multilayers of tests 4 and 5 appeared to be stable, but they did not pass the adhesion tests due to the delamination between the layer consisting of the compatibilizing terpolymer and the hot melt layer C′ and layer D consisting of thermoplastic polyurethane.

In example family 2, experiments are shown which were carried out in order to obtain a thermo-adhesive multilayer film that had the desired barrier properties and did not give any problems of delamination or adhesion between the layers by varying the rheology of the materials and their concentration in the mixture.

### Example 2.1

Fourteen extrusion tests were performed with a thermo-adhesive multilayer film according to the present invention, wherein layers A and C comprised a compound comprising a thermoplastic polyurethane and a compatibilizing agent for the purpose of increasing the compatibility between the various layers of the multilayer film.

TABLE 4

| Test | % TER | % TPU-1 | % TPU-2 |
|---|---|---|---|
| 6 | 20 | 80 | 0 |
| 7 | 25 | 75 | 0 |
| 8 | 30 | 70 | 0 |
| 9 | 35 | 65 | 0 |
| 10 | 40 | 60 | 0 |
| 11 | 45 | 55 | 0 |
| 12 | 50 | 50 | 0 |
| 13 | 20 | 0 | 80 |
| 14 | 25 | 0 | 75 |
| 15 | 30 | 0 | 70 |
| 16 | 35 | 0 | 65 |
| 17 | 40 | 0 | 60 |
| 18 | 45 | 0 | 55 |
| 19 | 50 | 0 | 50 |

For all tests, layer B was composed of 100% EVOH-3 and the subdivision of thicknesses was as follows:
layer A: 40 μm
layer B: 20 μm
layer C: 40 μm

These thicknesses enable flexible films to be obtained despite the greater stiffness of the barrier materials compared to the thermoplastic polyurethanes intended for use as an adhesive material for the clothing and footwear sectors, etc.

No particular extrusion problems were encountered except in tests 10, 11, 12, 17, 18 and 19, in which it was necessary to modify the settings of the extrusion system up to critical conditions; furthermore, the concentrations of the compatibilizing agent used in the aforesaid tests led to the production of a rigid multilayer film unsuitable for applications in the clothing and footwear sectors, etc.

The co-extruded trilayers A-B-C of tests 6, 7, 13 and 14 showed phenomena of cold delamination between layers A and B, and B and C, since the percentage of the compatibilizing terpolymer proved to be insufficient to counter the natural incompatibility between the thermoplastic polyurethane and EVOH barrier polymer.

The co-extruded trilayer films A-B-C obtained from tests 8, 9, 15 and 16 were bonded to a thermoplastic polyurethane decorative layer D applied as a coating of layer A, so as to form a decorative multilayer film. The properties of adhesion on fabric were then evaluated by means of the following tests.

TABLE 5

| | Materials | Test 20 | Test 21 | Test 22 | Test 23 |
|---|---|---|---|---|---|
| Layer D | monolayer (skin) | ✓ | ✓ | ✓ | ✓ |
| | bilayer | ✓ | ✓ | ✓ | ✓ |
| | (skin + Hot Melt) | | | | |
| Trilayer | TPU + TER/ | Test 8 of | Test 9 of | Test 15 of | Test 16 of |
| A-B-C | EVOH-3/TPU + TER | table 4 | table 4 | table 4 | table 4 |

In all four cases (tests 20, 21, 22 and 23), since layer C of the trilayer (test 8, test 9, test 15 and test 16 of table 4) comprises not only the compatibilizing agent but also the thermoplastic polyurethane, layer C also performs the function of a classic hot melt layer, enabling the adhesion of the multilayer film to a substrate without the need to add a further thermoplastic polyurethane layer C′ as was the case in example 1.2.

### Example 2.2

The decorative multilayer films obtained as per example 2.1 tests 20, 21, 22 and 23 were tested in order to evaluate their properties of adhesion and delamination on different substrates.

Said decorative multilayer films were applied to a textile substrate consisting of 73% polyamide and 27% elastane and the various decorated articles thus obtained were tested by evaluating the adhesion parameters before (decorated article as such—AS) and after washing (dry cleaning and in water at 60° C.).

As regards the process of bonding between the decorative layer D and trilayer A-B-C, for each multilayer film obtained with tests 20, 21, 22 and 23, the coating of layer A with the decorative layer D was carried out by calendering, both in the case of the monolayer decorative layer or “skin” and in the case of the “skin+hot melt” bilayer decorative layer using the following operating conditions for bonding.

TABLE 6

| | | |
|---|---|---|
| Bonding of layer D-layer A | Bilayer | Monolayer |

| | | | | |
|---|---|---|---|---|
| Calender temperature (° C.) | 120° | C. | 140° | C. |
| Belt speed (m/min) | 5 | m/min | 5 | m/min |

| | | |
|---|---|---|
| Pressure (bar) | 5 | 5 |

These operating conditions made it possible to obtain a decorative multilayer film, subsequently applied on the 73% polyamide and 27% elastane fabric substrate at a temperature of 120 and 140° C. for 20 seconds and 6 bar, which showed a low delamination of the product both before (decorated article as such—AS) and after washing (dry cleaning and in water at 60° C.).

For each of the bonded layers A-B-C-D deriving from the extrusion tests 20, 21, 22 and 23, tests were performed to evaluate resistance to adhesion after application on a fabric substrate, on the products AS and on the products subjected to washing (both dry cleaning and in water at 60° C.).

TABLE 7

| | | |
|---|---|---|
| | Substrate: | Tests 20, 21, |
| Test 24 | 73% polyamide, 27% elastane | 22 and 23 |

| | |
|---|---|
| Delamination | Low* |
| AS | Low* |
| Dry cleaning | Low* |
| Washing at 60° C. | Low* |

*low: adhesion >1 N/mm even if delamination of the layers occurs

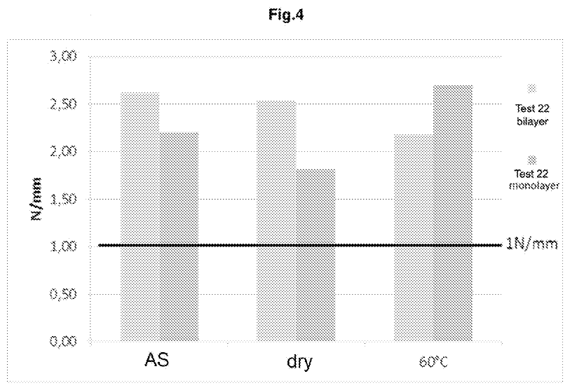

The multilayer decorative films of tests 20, 21, 22 and 23 further show good values of adhesion on the selected fabric substrate both at 120° C. and 140° C., as shown in FIG. 4 by way of example for test 22. Adhesion values were measured with a dynamometer according to standard ASTM D1876.

A Martindale abrasion test was also performed on these samples according to standard ASTM D4966-98, test passed with a score of 5/5.

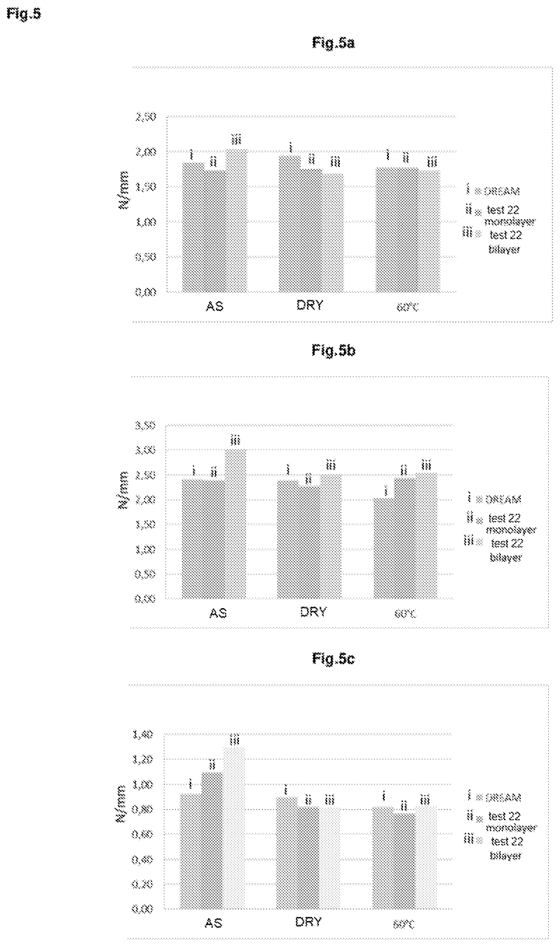

The adhesion and delamination tests were carried out by bonding the decorative multilayer films of tests 20, 21, 22 and 23 also to other types of substrates. In particular, FIG. 5 shows results of the adhesion test carried out by way of example for test 22 on the following fabrics: 78% polyamide and 22% elastane fabric (FIG. 5a), 100% polyester fabric (FIGS. 5b) and 79% polyamide and 21% elastane fabric (FIG. 5c), which are comparable to those obtained in the case of the 73% polyamide and 27% elastane substrate.

In said figures, the results of the adhesion test were further compared with the results obtained after bonding of solely the “dream” decorative layer (which does not have barrier or anti-dye migration properties) to the various substrates, but does not have problems of delamination.

However, despite the excellent adhesion properties and absence of delamination of the layers, following the bonding tests the decorative film showed aesthetic surface imperfections (orange-peel film) ascribable to an imperfect mixing between the thermoplastic polyurethane and compatibilizing terpolymer when only single-screw extrusion is used.

With the aim of increasing the degree of mixing of the granules making up layers A and C, tests were performed on the production of a compound of the compatibilizing terpolymer and the thermoplastic polyurethane:

| | | Test 25 | Test 26 | Test 27 | Test 28 |
|---|---|---|---|---|---|
| Layer A | TPU-1 | 30% | 35% | 0% | 0% |
| | TPU-2 | 0% | 0% | 30% | 35% |
| | TER | 70% | 65% | 70% | 65% |
| Layer B | EVOH | 100% | 100% | 100% | 100% |
| Layer C | TPU-1 | 30% | 35% | 0% | 0% |
| | TPU-2 | 0% | 0% | 30% | 35% |
| | TER | 70% | 65% | 70% | 65% |

Advantageously, the compound improves the uniformity of layers A and C, eliminating the orange-peel surface defect that appears following bonding with layer D. In particular, the improvement effect is more visible in tests 25 and 26, which involve the use of TPU1, as opposed to tests 27 and 28, which involve the use of TPU-2 as the thermoplastic polyurethane. This is ascribable to the smaller difference in terms of MFR between the three components of the TPU, EVOH and TER multilayer and thus to the greater rheological compatibility between the materials. The adhesion results were comparable to those of test 24; consequently, there were no problems of delamination of the layers on the various fabrics.

Example family 3 shows the dye migration tests performed on decorated articles of the present invention.

### Example 3.1

The samples of tests 25 and 26 (example 2.2), bonded to a decorative layer D according to parameters shown in Table 7, were subjected to migration tests following their application on fabrics which are known to lead to dye migration problems.

For every sample, the decorative multilayer film was cut into the shape of a rectangle having dimensions of 3 cm×4 cm and applied on the substrate by means of a press at 120° C. for 20 seconds and at 6 bar. For both samples, it was possible to observe that there was no migration of dye from the fabric to the decorative layer D, whether monolayer or bilayer.

Spectrophotometric measurements were also performed; they confirmed the preliminary visual evaluation, where one can observe that the samples analysed do not change appearance before and after application on the dyed fabric.

The dye migration test performed on said samples was further compared with the migration test performed, in parallel, on a sample composed of a trilayer consisting of:
layer A: polyurethane-based layer
layer B: polyurethane-based layer supplemented with a barrier agent for sublimation dyes based on cellulose acetate butyrate.
layer C: polyurethane-based hot melt layer necessary for ensuring adhesion on the substrate

The products were applied to two types of substrates, a sublimation substrate and a piece-dyed one, under the same conditions, and subjected to an accelerated migration test in a stove according to standards ISO 105 and AATCC Procedure 2. At the end of the test one clearly notes the dye migration that has occurred from the fabric up to the decorative layer in the case of the tested comparative sample. By comparing the latter with the samples of the present invention, it is possible to appreciate the clearly better barrier and anti-dye migration properties of the decorative multilayer films of the present invention.

1. A thermo-adhesive multilayer film comprising at least one barrier layer, said at least one barrier layer comprising at least one material with anti-dye migration properties selected from the group consisting of: ethylene vinyl alcohol copolymer (EVOH), polyvinyl alcohol (PVOH), polyvinyl acetate (PVAc), polyamides, cellulose derivatives, polyvinylidene chloride (PVDC) and combinations thereof, said at least one barrier layer being interposed between at least first and second layers, each comprising a mixture of at least one thermoplastic polyurethane with at least one compatibilizing agent, said at least one compatibilizing agent being selected from the group consisting of: co-polymers modified with maleic anhydride, co-polymers modified with epoxy groups, co-polymers containing hydroxyl groups and combinations thereof.

2. The thermo-adhesive multilayer film of claim 1, wherein the at least one thermoplastic polyurethane, the material of the at least one barrier layer and the at least one compatibilizing agent show a value of melt flow rate (MFR) measured at 190° C. and 2.16 kg according to standard ISO 1133 such that a difference between the MFR of the at least one thermoplastic polyurethane and the MFR of the material of the at least one barrier layer ranges between 10 g/10′ and 35 g/10′, and the difference between the MFR of the at least one compatibilizing agent and the MFR of the material of the at least one barrier layer is between 2 g/10′ and 5 g/10′.

3. The thermo-adhesive multilayer film of claim 1, wherein said co-polymers modified with maleic anhydride is an ethylene-vinyl acetate-maleic anhydride terpolymer.

4. The thermo-adhesive multilayer film of claim 1, wherein said at least one thermoplastic polyurethane is selected from the group consisting of polyester-based thermoplastic polyurethane, polycarbonate-based thermoplastic polyurethane, polyether-based thermoplastic polyurethane, aliphatic-based thermoplastic polyurethane, aromatic-based thermoplastic polyurethane and combinations thereof.

5. The thermo-adhesive multilayer film of claim 1, wherein the at least one barrier layer comprises said at least one material with anti-dye migration properties in an amount comprised from 90 to 100% by weight.

6. The thermo-adhesive multilayer film of claim 1, wherein the at least first and second layers each comprise a mixture comprising from 60 to 99% by weight of the at least one thermoplastic polyurethane and from 1 to 40% by weight of the at least one compatibilizing agent.

7. The thermo-adhesive multilayer film of claim 6, wherein the at least one thermoplastic polyurethane, the material of the at least one barrier layer and the at least one compatibilizing agent show a value of melt flow rate (MFR) measured at 190° C. and 2.16 kg according to standard ISO 1133 such that a difference between the MFR of the at least one thermoplastic polyurethane and the MFR of the material of the at least one barrier layer ranges between 10 g/10′ and 35 g/10′, and the difference between the MFR of the at least one compatibilizing agent and the MFR of the material of the at least one barrier layer is between 2 g/10′ and 5 g/10′, and wherein concentrations of the at least one thermoplastic polyurethane and of the at least one compatibilizing agent in the at least first layer and second layers are increased or decreased within concentration intervals, based on properties of melt flow index thereof compared to the melt flow index of the material of the at least one barrier layer B.

8. The thermo-adhesive multilayer film of claim 1, wherein thickness of the first layer is between 10 and 50 pm.

9. The thermo-adhesive multilayer film of claim 1, wherein thickness of the at least one barrier layer is between 1 and 70 pm.

10. The thermo-adhesive multilayer film of claim 1, wherein thickness of the second layer is between 10 and 90 pm.

11. A decorative multilayer film comprising a thermo-adhesive multilayer film comprising at least one barrier layer, said at least one barrier layer comprising at least one material with anti-dye migration properties selected from the group consisting of: ethylene vinyl alcohol copolymer (EVOH), polyvinyl alcohol (PVOH), polyvinyl acetate (PVAc), polyamides, cellulose derivatives, polyvinylidene chloride (PVDC) and combinations thereof, said at least one barrier layer being interposed between at least first and second layers, each of the first and second layers comprising a mixture of at least one thermoplastic polyurethane with at least one compatibilizing agent, said at least one compatibilizing agent being selected from the group consisting of co-polymers modified with maleic anhydride, co-polymers modified with epoxy groups, co-polymers containing hydroxyl groups and combinations thereof, and a decorative layer that coats at least one of said at least first and second layers, wherein said decorative layer comprises at least one material selected from among a thermoplastic polyurethane material, a fabric, a nonwoven fabric and combinations thereof.

12. The decorative multilayer film of claim 11, wherein said decorative layer has a decoration obtained by printing, said decoration being selected from the group consisting of an image, a wording, a drawing, a logo, a mark, a geometric pattern and a design motif.

13. A method for preventing dye migration in applications that envisage bonding a decorative layer to a substrate said method comprising using the thereto-adhesive multilayer film of claim 1.

14. A method for decorating substrates of textiles, clothing, shoes, accessories and furnishing elements, said method comprising using the decorative multilayer film of claim 11.

15. A decorated article obtainable by applying the decorative multilayer film of claim 11 on a substrate, wherein said substrate is selected from a fabric or a nonwoven fabric made of natural or synthetic fibres and said substrate is a surface of a furnishing element, an item of clothing, a shoe or a fashion accessory.

16. The decorative multilayer film of claim 11, wherein said thermoplastic polyurethane material is selected from the group consisting of polyester-based thermoplastic polyurethane, polycarbonate-based thermoplastic polyurethane, polyether-based thermoplastic polyurethane, aliphatic-based thermoplastic polyurethane, aromatic-based thermoplastic polyurethane and combinations thereof.

17. The decorative multilayer film of claim 11, wherein said decorative layer further comprises at least one pigment or at least one dye.

18. The thereto-adhesive multilayer film of claim 1, wherein the at least first and second layers each comprise a mixture comprising from 65 to 95% by weight of the at least one thermoplastic polyurethane and from 5 to 35% by weight of the at east one compatibilizing agent.

19. The thereto-adhesive multilayer film of claim 1, wherein the at least first and second layers each comprise a mixture comprising from 70 to 90% by weight of the at least one thermoplastic polyurethane and from 10 to 30% by weight of the at least one compatibilizing agent.

20. The thereto-adhesive multilayer film of claim 1, wherein the at least first and second layers each comprise a mixture comprising from 65 to 80% by weight of the at least one thermoplastic polyurethane and from 20 to 35% by weight of the at least one compatibilizing agent.

21. The thereto-adhesive multilayer film of claim 1, wherein the at least first and second layers each comprise a mixture comprising from 65 to 75% by weight of the at least one thermoplastic polyurethane and from 25 to 35% by weight of the at least one compatibilizing agent.

22. The thereto-adhesive multilayer film of claim 1, wherein the at least one thermoplastic polyurethane, the material of the at least one barrier layer and the at least one compatibilizing agent show a value of melt flow rate (MFR) measured at 190° C. and 2.16 kg according to standard ISO 1133 such that a difference between the MFR of the at least one thermoplastic polyurethane and the MFR of the material of the at least one barrier layer ranges between 12 g/10′ and 32 g/10′, and the difference between the MFR of the at least one compatibilizing agent and the MFR of the material of the at least one barrier layer is between 2 g/10′ and 5 g/10′.

23. The thermo-adhesive multilayer film of claim 1, wherein the at least one thermoplastic polyurethane, the material of the at least one barrier layer and the at least one compatibilizing agent show a value of melt flow rate (MFR) measured at 190° C. and 2.16 kg according to standard ISO 1133 such that a difference between the MFR of the at least one thermoplastic polyurethane and the MFR of the material of the at least one barrier layer ranges between 14 g/10′ and 20 g/10′, and the difference between the MFR of the at least one compatibilizing agent and the MFR of the material of the at least one barrier layer is between 2 g/10′ and 5 g/10′.

24. The thermo-adhesive multilayer film of claim 1, wherein the at least one barrier layer comprises said at least one material with anti-dye migration properties in an amount comprising from 95 to 100% by weight.

25. The thermo-adhesive multilayer film of claim 1, wherein the at least one barrier layer comprises said at least one material with anti-dye migration properties in an amount comprising from 99 to 100% by weight.

26. The thereto-adhesive multilayer film of claim 1, wherein thickness of the first layer is between 30 and 40 pm.

27. The thermo-adhesive multilayer film of claim 1, wherein thickness of the first layer is between 35 and 45 pm.

28. The thereto-adhesive multilayer film of claim 1, wherein thickness of the at least one barrier layer is between 10 and 30 pm.

29. The thereto-adhesive multilayer film of claim 1, wherein thickness of the at least one barrier layer is between 15 and 25 pm.

30. The thereto-adhesive multilayer film of claim 1, wherein thickness of the second layer is between 30 and 50 pm.
